(19) United States
(12) Patent Application Publication
(10) Pub. No.: US 2005/0023026 A1
(43) Pub. Date: Feb. 3, 2005

(54) Network cable

(76) Inventor: Wilson Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/627,695

(22) Filed: Jul. 28, 2003

(51) Int. Cl. H02G 15/02

(52) U.S. Cl. 174/74 R

(57) ABSTRACT

A network cable capable of obtaining the necessary working power supply for its internal control circuit that detects the connection and transmission status of the transmission line and drives an indicator light to give a visual indication signal indicative of the detection result.

### BACKGROUND OF THE INVENTION

1. Field of the Invention

The present invention relates to a network cable and, more particularly, to such a network cable, which automatically detects the operation status of the transmission line, and gives a visual indication indicative of the detection result.

2. Description of the Related Art

Referring to FIGS. 1 and 2, in a computer network, network cables 16 and hubs 12 are used to link computers 10. Each network cable comprises a transmission line 16, and two module plugs 18 respectively provided at the ends of the transmission line 16 and respectively connected to one module jack 14 in a hub 12 (see FIG. 2) and one module jack in one computer 10. In case the computer network fails to function normally, it is difficult to find the trouble from the network cables and hubs in the computer network. Therefore, it is desirable to provide a network cable that automatically detects the operation status of the transmission line and gives a visual indication indicative of the detection result. It is easy to provide a control circuit in a network cable for detecting the operation status of the transmission line and driving an indicator light. However, it is not easy to obtain the necessary working voltage for the control circuit in the network cable.

### SUMMARY OF THE INVENTION

The present invention has been accomplished under the circumstances in view. It is the main object of the present invention to provide a network cable, which automatically detects the operation status of the transmission line and indicates the detection result, so that the user can easily find the trouble when the network system fails to function normally. It is another object of the present invention to provide an indicative network cable, which is practical for use in any of a variety of networks, including computer networks, audio/video networks, communication networks, and etc.

To achieve these and other objects of the present invention, the network cable comprises a transmission line, two module plugs respectively provided at two ends of the transmission line for connection to a computer and a network respectively, a plurality of indicator lights respectively installed in the module plugs, two control lines respectively extended from the module plugs, and two electric adapters respectively provided at the ends of the control lines remote from the module plugs, the electric adapters each comprising a female connector, a male connector matching the female connector, and a control circuit adapted to obtain external power supply through one of the male connector and the female connector and to detect the connection status of the transmission line between the computer and the network and to control the operation of the indicator lights subject to the detection result. Further, the electric adapters can be made in any of a variety of forms, for example, USB PORT type, COMMON PORT type, PS2 PORT type, or HUB type adapters.

### BRIEF DESCRIPTION OF THE DRAWINGS

FIG. 1 is a schematic drawing showing a conventional computer network.

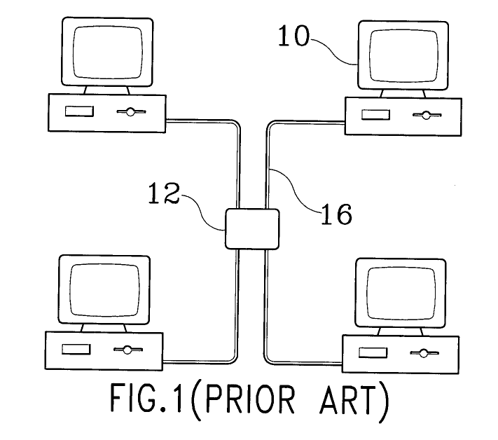

FIG. 2 illustrates two network cables connected to a hub according to the prior art.

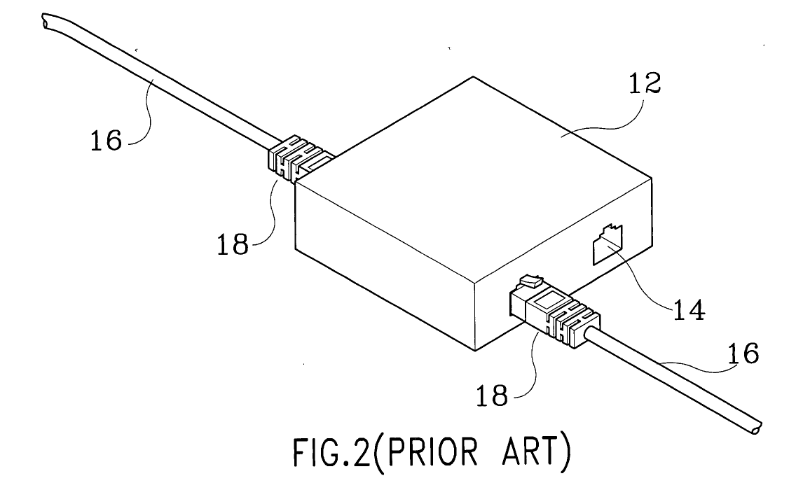

FIG. 3 illustrates the structure of a network cable according to the present invention.

FIG. 4 is an enlarged view, partially cutaway, of a part of the network cable shown in FIG. 3.

FIG. 5 illustrates an application example of the present invention, showing two network cables installed in a hub.

FIG. 6 is schematic drawing showing an operation status of FIG. 5.

### DETAILED DESCRIPTION OF THE PREFERRED EMBODIMENT

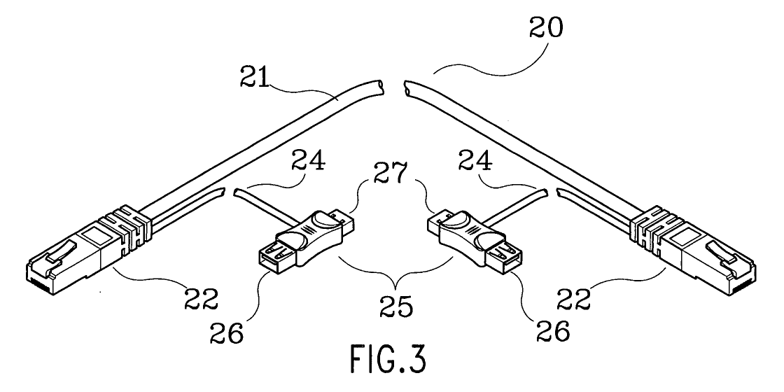

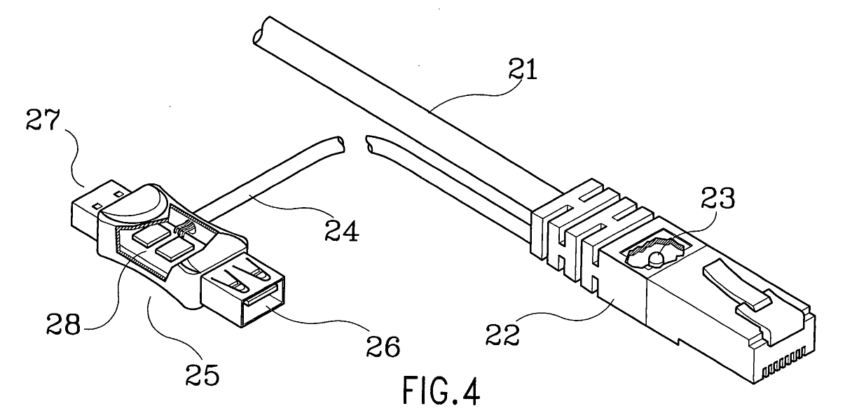

Referring to FIGS. 3 and 4, a network cable 20 is shown comprising a transmission line 21 having a certain length, two transparent module plugs 22 respectively located on the ends of the transmission line 21, two control lines 24 respectively extended from the module plugs 22, and two electric adapters 25 respectively located on the ends of the control lines 24 remote from the module plugs 22. The electric adapters 25 each comprise a female connector 26 at one end, a male connector 27 at the other end, and a control circuit 28 on the inside. Further, each module plug 22 has installed therein an indicator light, for example, a LED (light emitting diode) 23.

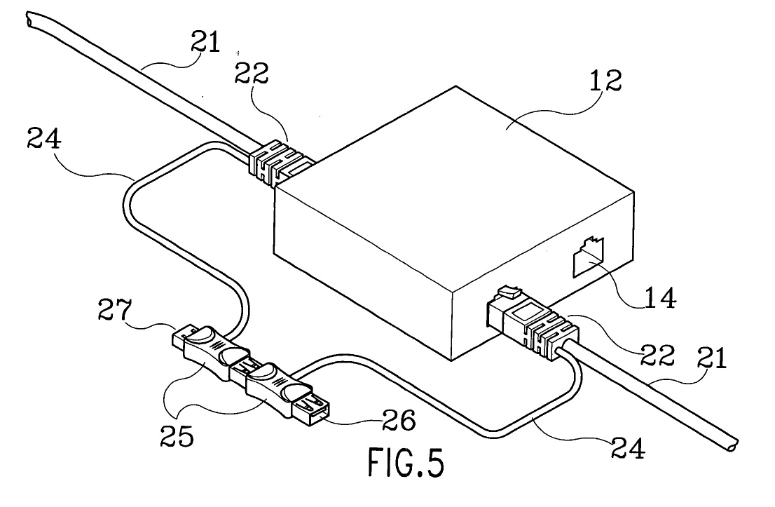

FIG. 5 shows two network cables connected to a hub 12. The electric adapters 25 can be USB PORT type, COMMON PORT type, PS2 PORT type, or HUB type adapters. According to the present preferred embodiment, the electric adapters 25 are USB PORT type adapters.

Referring to FIGS. 3 and 5 again, one module plug 22 of each network cable 20 is connected to the network card port of the computer (not shown) with the male connector 27 of the corresponding electric adapter 25 connected to the USB port of the computer to obtain the necessary working voltage for the control circuit 28, and the other module plug 22 of the respective network cable 20 is connected to one module jack 14 of the hub 12. The control circuit 28 detects the installation of the transmission line 21, and controls the operation of the LEDs 23 in the module plugs 22 subject to the detection result. If the network cable 20 is properly installed in the network, the control circuit 28 drives on the LEDs 23, keeping the LEDs 23 constantly in ON status. Upon transmission of a signal through the network cable 20, the control circuits 28 drives the LEDs 23 to flash. On the contrary, if the connection of the network cable 20 is abnormal or if the network cable 20 is disconnected, the control circuit 28 receives no signal from the network, the LEDs 23 will not go flash. Further, when one electric adapter 25 installed in the USB port of the computer, the female connector 26 is in vacant for receiving the USB connector of an external computer peripheral apparatus to electrically connect the external computer peripheral apparatus to the USB port of the computer.

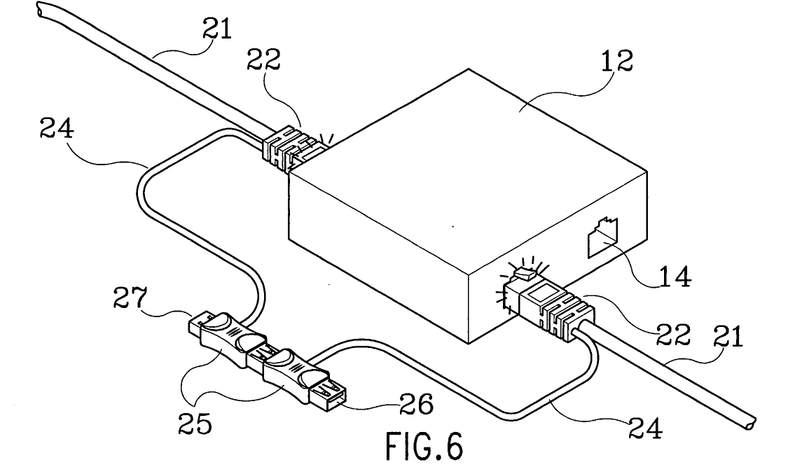

Referring to FIGS. 5 and 6 again, the two proximity electric adapters 25 of the two network cables being connected to the hub 12 are connected together by fastening the female connector 26 of the proximity electric adapter 25 of one network cable to the male connector 27 of the proximity electric adapter 25 of the other network cable, enabling electricity to be supplied to the control circuit 28 of each electric adapter 25. Therefore, the control circuits 28 of the proximity electric adapters 25 of the two network cables being connected to the hub 12 detect the connection status of the respective signal lines 21 independently without causing interference.

As indicated above, the network cable automatically detects the connection status of the respective transmission line and gives a visual signal indicative of the detected result. Because the transmission line 21 of the network cable serves as signal carrier means for transmission of signal, it does not provide sufficient voltage and current for starting the control circuits 28 and the LEDs 23. Therefore, added power supply is necessary to start the control circuits 28 and the LEDs 23. By means of the electric adapters 25, the network cable obtains the necessary working voltage from the computer for starting the control circuits 28 and the LEDs 23. The design of the present invention can be employed to any kind of networks, including computer networks, audio/video networks, communication networks, and etc.

A prototype of network cable has been constructed with the features of FIGS. 3˜6. The network cable functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. A network cable comprising a transmission line, two module plugs respectively provided at two ends of said transmission line for connection to a computer and a network respectively, a plurality of indicator lights respectively installed in said module plugs, two control lines respectively extended from said module plugs, and two electric adapters respectively provided at the ends of said control lines remote from said module plugs, said electric adapters each comprising a female connector, a male connector matching said female connector, and a control circuit adapted to obtain external power supply through one of said male connector and said female connector and to detect the connection and operation status of said transmission line between said computer and said network and to control the operation of said indicator lights subject to the detection result.
